(19) United States
(12) Patent Application Publication
(10) Pub. No.: US 2024/0148018 A1
(43) Pub. Date: May 9, 2024

(54) Stabilized Frozen Dairy Products and Mixes Comprising Denaturized Whey Protein

(71) Applicant: General Mills, Inc., Minneapolis, MN (US)

(72) Inventors: Arnaud Mimouni, Lyon (FR); Sophie Aubert, Vienne (FR); Lucile Mayeux, Lyon (FR)

(73) Assignee: General Mills, Inc., Minneapolis, MN (US)

(21) Appl. No.: 18/280,366

(22) PCT Filed: Mar. 12, 2021
(86) PCT No.: PCT/IB2021/000154

§ 371 Date: Sep. 5, 2023

(51) Int. Cl. A23G 9/40; A23C 9/13

(52) U.S. Cl. CPC A23G 9/40; A23C 9/1307; A23C 2260/152

(57) ABSTRACT

Mixes for making frozen dairy products that include 1% to 5% denaturized whey protein, and products made from such mixes, are described. Methods of making mixes including denaturized protein are described, as well as methods for making frozen dairy products from such mixes.

### BACKGROUND

Consumers enjoy dessert products intended to be consumed while frozen, such as ice cream, frozen yogurt, ice milk, mellorines, sherbets and water ices. Ice cream is a frozen food product prepared from a mixture of dairy ingredients, sweeteners, stabilizers and emulsifiers which are pasteurized, homogenized, flavored and frozen usually under agitation while air is incorporated. Ice milk is similar to ice cream but contains less milk fat. Mellorine is similar to ice cream except that the butterfat is replaced with vegetable fats. Sherbet is a frozen dessert characterized by its tart flavour which results from adding fruit or fruit juices along with dairy ingredients and may also have added fruit acid. Sherbet is prepared from the same basic ingredients as ice cream, although the maximum total milk solids content is about 25 percent that of ice cream. Frozen water ices are a frozen product prepared from water, sugar and fruit juices, stabilizer, with or without additional acid and color, and containing no dairy product. Water ices differ from ice cream in that the overrun, or amount of air incorporated during the manufacturing process is substantially lower than that of ice cream. Frozen yogurt is a frozen dessert made with yogurt and sometimes other dairy and non-dairy products. Frozen yogurt may contain live and active bacteria cultures.

Regulatory standards of identity exist for each of these frozen desserts in certain countries, including the United States. Ice cream, by United States standards, must comprise at least 10% and can comprise up to 18% fat. Ice cream manufacturing is considered a developed art. Formulation, preparation and general description of ice cream is described in “Ice Cream,” fourth ed. by W. S. Arbuckle, The Avi Publishing Company, Inc., Westport, C T 1986.

### SUMMARY OF THE INVENTION

The present invention concerns frozen dairy products, and in particular ice creams and frozen yogurts. In particular, the invention concerns the use of whey protein to stabilize such products.

An aim of the present invention includes providing frozen dairy products (e.g., ice cream or frozen yogurt) with improved stability, notably with respect to the growth of water ice crystals. In particular, the present invention aims at solving the technical problem of providing frozen dairy products with limited growth of water ice crystals perceivable by consumers, as large water ice crystals or growth of water ice crystals is considered as a major defect (“iciness”).

The present invention also aims at solving the technical problem of preventing ice crystal growth in frozen dairy product during shelf-life. In particular, the present invention aims at solving the technical problem of providing frozen dairy products with limited iciness while avoiding including stabilizers not from dairy origin.

The present invention also aims at solving the technical problem of providing a method or process for increasing ice crystal stability of frozen dairy products.

The present invention aims at solving the technical problem of providing frozen dairy products with improved stability, notably with respect to the melting resistance of the product. In other words, the present invention aims at solving the technical problem of providing frozen dairy products with a slow melting rate, especially to limit or even avoid shape deformation and stickiness on packaging, particularly during the transport from shop to home.

The present invention also aims at solving the technical problem of preventing melting of frozen dairy products during transport or eating by consumers. In particular, the present invention aims at solving the technical problem of providing frozen dairy products with improved melt resistance while avoiding including stabilizers not from dairy origin.

The present invention also aims at providing a mix for such frozen dairy products.

A mix for a frozen dairy product having a pH below 5 is provided herein. The mix includes denaturized whey protein at a concentration of at least 1%, at least 1.5%, or at least 2%, by weight relative to the total weight of the mix, excluding the weight of solid inclusions, if any. In some embodiments, the mix can have a denaturized whey protein content of about 2% to about 5% by weight of the mix. In some embodiments, the frozen dairy product can be a frozen yogurt. In some embodiments, the mix can include, by weight of the mix, excluding the weight of solid inclusions, if any, fat in amount of about 8% to about 13%, milk solids nonfat (MSNF) in an amount of about 10% to about 15%, added sugar in an amount of about 8% to about 15%, egg yolk solids in an amount of about 1% to about 5%, total solids in an amount of about 35% to about 45%, and yogurt in an amount of about 29% to about 38%.

A frozen dairy product having a pH below 5 is provided. The product includes a mix having a pH below 5.

A mix for a frozen dairy product having a pH of at least 5 is provided herein. The mix includes denaturized whey protein at a concentration of at least 1%, at least 1.5%, or at least 2%, by weight relative to the total weight of the mix, excluding the weight of solid inclusions, if any. In some embodiments, the mix can include denaturized a whey protein content of about 2% to about 5% by weight of the mix. In some embodiments, the frozen dairy product can be an ice cream or a gelato. In some embodiments, the mix can include, by weight of the mix, excluding the weight of solid inclusions, if any, fat in amount of about 11% to about 25%, milk solids nonfat (MSNF) in an amount of about 6% to about 13%, added sugar in an amount of about 8% to about 25%, egg yolk solids in an amount of about 1% to about 8%, and total solids in an amount of about 40% to about 55%. In some embodiments, the mix can include, by weight of the mix, excluding the weight of solid inclusions, if any, fat in amount of about 3% to about 10%, milk solids nonfat (MSNF) in an amount of about 6% to about 10%, added sugar in an amount of about 1% to about 5%, egg yolk solids in an amount of about 2% to about 5%, and total solids in an amount of about 35% to about 45%.

A frozen dairy product having a pH of at least 5 is provided. The product includes a mix having a pH of at least 5.

A process for preparing a mix for a frozen dairy product is also provided. The process includes adding denaturized whey protein to other ingredients to form the mix, or adding exogenous native whey protein to other ingredients and denaturing the exogenous native whey protein at least in part to form the mix. In some embodiments, the process can include a pasteurization of the mix, where the pasteurization step also denatures at least in part the exogenous native whey protein in the mix. In some embodiments, pasteurization can be performed at a temperature in the range of 85° C. to 100° C. In some embodiments, the process can include a step of freezing the mix to produce a frozen dairy product.

In some embodiments, a mix having a pH below 5 can be obtained from process for preparing a mix for a frozen dairy product, which is provided herein.

In some embodiments, a mix having a pH of at least 5 can be obtained from process for preparing a mix for a frozen dairy product, which is provided herein.

A method for stabilizing ice crystals in a frozen dairy product is provided herein. The method includes adding exogenous whey protein to a mix for a frozen dairy product, where the added whey protein is in the form of denaturized whey protein prior to addition to the mix, or is denaturized prior to freezing the mix.

A method for improving melting resistance in a frozen dairy product is provided herein. The method includes adding denaturized whey protein to a mix for a frozen dairy product, where the added whey protein being in the form of denaturized whey proteins prior to addition to the mix, or is denaturized prior to freezing the mix.

Use of denaturized whey proteins for improving melting resistance or slowing down the melting of a frozen dairy product having a pH below 5, where the frozen dairy product includes a mix having a pH below 5 is provided. Use of denaturized whey proteins for improving melting resistance or slowing down the melting of a frozen dairy product having a pH below 5, where the mix is obtainable according to a disclosed process is provided.

Use of denaturized whey proteins for improving melting resistance or slowing down the melting of a frozen dairy product having a pH of at least 5, where the frozen dairy product includes a mix having a pH of at least 5 is provided. Use of denaturized whey proteins for improving melting resistance or slowing down the melting of a frozen dairy product having a pH of at least 5, where the mix is obtainable according to a disclosed process is provided.

These and various other features and advantages will be apparent from a reading of the following detailed description.

### DETAILED DESCRIPTION OF THE INVENTION

During storage of frozen dairy products, particularly storage of ice cream or frozen yogurt, water ice crystals can grow, making them perceivable by consumers which is considered as a major defect (iciness). Stabilizers can be used to control ice crystal growth and reduce or prevent perceived iciness. Such stabilizers include, for example, polysaccharides such as starch, gums, carrageenans, and pectins. However, those stabilizers are not from dairy origin, and many consumers prefer that frozen dairy products do not include non-dairy stabilizers. Unfortunately, to the present inventors' knowledge, there is no known technology to increase ice crystal stability of frozen dairy products, particularly of ice cream or frozen yogurt, that use dairy ingredients.

It has been surprisingly discovered by present inventors, and is disclosed herein, that frozen dairy products having denaturized whey proteins have reduced development of iciness during storage, even if no non-dairy stabilizers are included. Without being bound by theory, it is believed that denaturized whey proteins can form a gel, which when included in a frozen dairy product, entraps free water, limiting crystal formation during storage.

It was also unexpectedly discovered that including a denaturized whey protein in a frozen dairy product can improve melt resistance during storage, transportation, or consumption. Without being bound by theory, it is believed that a denaturized whey gel included in a frozen dairy product can provide structure to the frozen dairy product at temperatures that would be expected to cause melting, thereby reducing or delaying melting.

It was surprisingly discovered that the benefits of including denaturized whey protein can be achieved in low pH frozen dairy products (e.g., a pH less than 5, or a pH of less than 4.8), such as in a frozen yogurt product, where the presence of free calcium can increase the gelling properties of denaturized whey protein in the mix, as well as in frozen dairy products with a more neutral pH (e.g., a pH of at least 5), such as in an ice cream or gelato product, where little to no free calcium is available.

Thus, frozen dairy products, and mixes for making such frozen dairy products, containing denaturized whey disclosed herein can beneficially have reduced iciness over storage and/or have improved resistance to melting. In some cases, frozen dairy products that are more susceptible to iciness and melting, such as frozen dairy products with reduced or low fat content, can benefit from including denaturized whey to reduce susceptibility to iciness and melting.

Frozen Dairy Product and Mix

A mix for preparing a frozen dairy product is provided herein that takes advantage of the discoveries described above. In the present application, “mix” designates a mix for preparing frozen dairy products unless stated otherwise. A mix includes denaturized whey protein at a concentration of at least 1% (e.g., at least 1.5%, at least 2%, or about 2% to about 5%) by weight relative to the total weight of the mix. As used herein, unless specified otherwise, the content or concentration of mix components is expressed in percent (%) by weight relative to the total weight of the mix, excluding the weight of solid inclusions if any. As used herein, the content or concentration of denaturized proteins in the mix does not include the content of denaturized whey protein endogenous to a yogurt included in the mix, if any. That is, in the specific case of frozen yogurt, yogurt included in the mix may contain endogenous denaturized proteins; such denaturized proteins in the yogurt are excluded from calculating the content or concentration of denaturized protein in the mix for the purposes of the present invention. Denaturized whey proteins are typically insoluble in water at pH of 4.6 whereas native whey proteins are typically soluble in water at pH of 4.6.

In some embodiments, an acidic pH (e.g., pH of less than 5, or pH of less than 4.8), such as in a frozen yogurt product, can release calcium from a dairy ingredient increase the gelling properties of denaturized whey protein in the mix. In such embodiments, pH can be adjusted, for example, fruit juice or citric acid. However, inclusion of denaturized whey protein surprisingly provides the desired stability, even at a pH above 5, such as in an ice cream or gelato product, where little to no free calcium is available.

Denaturized whey protein can be obtained by exposing a liquid composition containing native whey protein to a thermal treatment at a temperature and for a time sufficient to denature the native whey protein in the composition. While a range of appropriate temperatures and times would be recognized by a person having ordinary skill in the art, it is generally suitable to treat a liquid composition containing native whey protein at a temperature exceeding 85° C. (e.g., about 85° C. to about 105° C., or about 86° C. to about 92° C.) for several minutes (e.g., from about 2 minutes to about 10 minutes, or about 5 minutes to about 8 minutes) to produce a denaturized whey protein. For example, denaturized whey protein can be made by treating a liquid composition containing native whey protein at temperature of about 88° C. to about 90° C. for about 5 minutes to about 8 minutes.

In some embodiments, exogenous whey protein can be denaturized by preparing a solution of native whey proteins, then heating at a temperature and holding time sufficient to denature the native whey protein into denaturized whey protein. For example, such a whey protein solution can be at a concentration of 5 to 10% by weight relative to the total weight of the solution. Heat treatment of a whey protein solution can be at a temperature of, for example, about 85° C. to about 95° C. Heat treatment of a whey protein solution can be for a time range of about 5 to about 30 minutes. In some embodiments, denaturized whey protein can be in the form of a suspension or of a solution. In some embodiments, denaturized whey protein can be dried, e.g., by lyophilization or spray drying.

In some embodiments, a native whey can be denatured prior to addition to a mix described herein. A denaturized whey can be added to a mix as a liquid (e.g., a denaturized whey protein solution) or can be dried and added as a powder to a mix. In some embodiments, exogenous native whey can be added to a mix and the mix can be thermally treated to denature the exogenous native whey protein.

As used herein, the term “exogenous whey protein” refers to whey protein added in addition to those naturally present in milk or yogurt used to prepare the mix for the frozen dairy product.

Advantageously, in some embodiments, exogenous whey protein in a mix provided herein need not be concentrated or purified whey protein (e.g., a whey protein concentrate or a whey protein isolate) to be effective as a source of denaturized whey protein. For example, in some embodiments, skim milk powder or condensed skim milk (also called concentrated skim milk herein) can be included in a mix as a source of exogenous whey protein. As a result, such whey proteins may be recognized by consumers as regular ingredients for frozen dairy products, such as for ice cream, frozen yogurt or gelato formulations.

The mix can contain other proteins than whey proteins. For example, the proteins in the mix can include endogenous milk proteins, typically from concentrated milk, cream, and/or egg yolk proteins. Preferably, the mix comprises from about 2% to about 6% of protein relative to the total weight of the mix, not including denaturized whey protein. That is, total protein content, including denaturized whey protein, can be from about 3% to about 12% by weight of a mix.

In some embodiments, the mix can comprise casein proteins. Casein protein in a mix can include caseins endogenous to a milk or yogurt ingredient, or can be added as an exogenous casein protein. In some embodiments, a mix contains only casein protein that is endogenous in milk or yogurt used to prepare the mix for the frozen dairy product.

A frozen dairy product, such as for example ice creams, gelatos, or frozen yogurts, or mixes for preparing frozen dairy product contain one or more dairy ingredients. A dairy ingredient can be fermented or non-fermented. Fermented dairy products, typically refer to compositions produced by culturing (fermenting) one or more dairy ingredients, also sometimes referred to as a dairy base, with a bacterial culture that contains the lactic acid-producing bacteria, such as Lactobacillus bulgaricus and/or Streptococcus thermophilus. Such products are available in a wide variety of styles and formulations.

Appropriate dairy ingredients for use in a mix or frozen dairy product provided herein include, without limitation, cream, dried cream, yogurt, plastic cream (also known as concentrated milk fat), butter, butter oil, milk, concentrated milk, evaporated milk, sweetened condensed milk, superheated condensed milk, dried milk, skim milk, concentrated skim milk, evaporated skim milk, condensed skim milk, superheated condensed skim milk, sweetened condensed skim milk, sweetened condensed part skim milk, powder skim milk, nonfat dry milk, sweet cream buttermilk, condensed sweet cream buttermilk, dried sweet cream buttermilk, skim milk that has been concentrated and from which part of the lactose has been removed by crystallization, skim milk in concentrated or dried form which has been modified by treating the concentrated skim milk with calcium hydroxide and disodium phosphate, and whey and those modified whey products—such as reduced lactose whey, reduced minerals whey, and whey protein concentrate for example that have been determined by the Food and Drug Administration to be generally recognized as safe (GRAS) for use in this type of food. In some embodiments, water may be added, or water may be evaporated from a dairy ingredient. For example, sweet cream buttermilk and concentrated sweet cream buttermilk or dried sweet cream buttermilk, when adjusted with water to a total solids content of 8.5%, has a titratable acidity of not more than 0.17%, calculated as lactic acid. Preferably, the term “milk” means cow's milk, but can include a milk from any suitable mammal.

A concentrated skim milk can be made from skim milk having a solids content of, typically, about 9%, via ultrafiltration to about 20% to about 23% (e.g., about 22% to about 23%) solids content, vacuum evaporation to about 20% to about 40% (e.g., about 27% to about 37%) solids content, or other suitable concentration technique.

In some embodiments, yogurt can be included in a mix for frozen dairy product in an amount of between about 29% to about 38% (e.g., about 33% to about 36%) by weight of the mix. A yogurt can be made using any known process from any appropriate milk ingredient. In some embodiment, a yogurt can be a whole milk yogurt.

Fat content in a mix provided herein can be from about 3% to about 35% by weight relative to the total weight to the mix. In some embodiments, such as in a mix suitable for making an ice cream, the mix can have a fat content of about 11% to about 25% (e.g., about 11 to 22%) by weight relative to the total weight to the mix. In some embodiments, such as in a mix suitable for making a frozen yogurt, the mix can have a fat content of about 8% to about 13% (e.g., about 9% to 12%) by weight relative to the total weight to the mix. In some embodiments, such as in a mix suitable for making a gelato, the mix can have a fat content of about 3% to about 10% (e.g., about 4% to about 9%) by weight relative to the total weight to the mix. In some embodiments, a mix provided herein can contain a fat amount less than typically included for a particular type of frozen dairy product. For, a mix provided herein that contains denaturized whey protein can be formulated to make an ice cream with a fat content less than 11%, yet retain superior resistance to iciness and melting.

In some embodiments, a mix can include a vegetable butter such as, for example, cocoa butter, peanut butter, almond fat, hazelnut fat, or coconut fat.

As used herein, “vegetable butter” (also “botanical butter”) is a triglyceride comprising saturated and unsaturated fatty acids from a plant. Generally, a vegetable butter includes a fat and/or oil extract of a plant fruit and/or seed having a melting point above 20° C. and usually above 25° C. and usually near 30-40° C.

In some embodiments, a vegetable butter can also serve as a flavorant in a mix. For example, such flavorants can include for example cocoa butter, peanut butter, almond fat, hazelnut fat, or coconut fat.

In some embodiments, heavy cream and/or egg yolks can contribute a fat to a mix. Heavy cream usually contains about 40% fat and about 45% solids. Fat in cream, milk, or egg yolk is considered to be endogenous fat in a mix or frozen dairy product provided herein.

In some embodiments, a mix or frozen dairy product provided herein can contain fat naturally occurring in flavorants, such as cocoa powder.

In some embodiments, a mix can include milk solid non-fat (MSNF). In some embodiments, such as in a mix suitable for making an ice cream, MSNF can be included in a mix in an amount of about 6% to about 13% (e.g., about 7% to about 12%) by weight relative to the total weight of the mix. In some embodiments, such as in a mix suitable for making a frozen yogurt, MSNF can be included in a mix in an amount of about 10% to about 15% (e.g., about 11% to about 14%) by weight relative to the total weight of the mix. In some embodiments, such as in a mix suitable for making a gelato, MSNF can be included in a mix in an amount of about 6% to about 10% (e.g., about 7% to about 9%) by weight relative to the total weight of the mix.

A mix provided herein typically contains sugar. A sugar may be selected from monosaccharides, disaccharides, oligosaccharides, and mixtures thereof. Suitable examples include sucrose, fructose, lactose, glucose and corn syrups.

In some embodiments, a mix contains added sugar. As used herein, the term “added sugar” means sugar added in addition to the sugar endogenous to other ingredients. Other ingredients, such as dairy ingredients or flavorants, may contain naturally occurring sugar, which is not considered “added sugar”.

In some embodiments, a mix comprises added sugar in an amount of about 1% to about 25% (e.g., about 2% to 20%) by weight relative to the total weight of the mix. In some embodiments, such as in a mix suitable for making an ice cream, a mix can include added sugar in an amount of about 8% to 25% (e.g., about 10% to 20%) by weight relative to the total weight of the mix. In some embodiments, such as in a mix suitable for making a frozen yogurt, a mix can include added sugar in an amount of about 8% to 15% (e.g., about 9% to 13%) by weight relative to the total weight of the mix. In some embodiments, such as in a mix suitable for making a gelato, a mix can include added sugar in an amount of about 1% to 5% (e.g., about 2% to 3%) by weight relative to the total weight of the mix.

A mix provided herein can contain egg yolk solids. In some embodiments, a mix can have an egg yolk solids content of about 1% to about 8% (e.g., about 2% to 6%) by weight relative to the total weight of the mix. In some embodiments, such as in a mix suitable for making an ice cream, a mix can have an egg yolk solids content of about 1% to about 8% (e.g., about 2% to 6%) by weight relative to the total weight of the mix. In some embodiments, such as in a mix suitable for making a frozen yogurt, a mix can have an egg yolk solids content of about 1% to about 5% (e.g., about 2% to 4%) by weight relative to the total weight of the mix. In some embodiments, such as in a mix suitable for making a gelato, a mix can have an egg yolk solids content of about 2% to about 5% (e.g., about 3% to 4%) by weight relative to the total weight of the mix.

Suitable sources of egg yolk solids include liquid egg yolks, frozen egg yolks, dried egg yolks, liquid whole eggs, frozen whole eggs, dried whole eggs, or a combination thereof. Pasteurized liquid frozen egg yolk is often sold for commercial purposes with about 10% sucrose added. Egg yolks can help emulsify the other ingredients and include about 20% to about 24% by weight of fat, typically about 22% by weight of fat with respect to the weight of egg yolk.

In some embodiments, a mix or frozen dairy product can also contain suitable emulsifiers other than egg yolk.

A mix provided herein can have a total solids content of about 35% to about 55% (e.g., about 37% to about 51%) by weight relative to the total weight of the mix. In some embodiments, such as in a mix suitable for making an ice cream, a mix can have a total solids content of about 40% to 55% (e.g., about 41% to about 51%) by weight relative to the total weight of the mix. In some embodiments, such as in a mix suitable for making a frozen yogurt or a gelato, a mix can have a total solids content of about 35% to 45% (e.g., about 39% to about 43%, or about 37% to about 44%, respectively) by weight relative to the total weight of the mix. As used herein, the term “solids content” does not refer to solid inclusions. Measurement of total solid content and fat content after homogenization may be determined according to the present invention as described in the examples.

A mix or frozen dairy product provided herein can also include flavorants such as, for example, vanilla, chocolate, coffee, fruit, nuts, liqueur, vegetable, tea, and candy. These flavorants can be provided in the form of a powder, puree, paste, syrup, concentrate, extract, alcohol, liquid, solid inclusions, or a combination thereof. Flavorants can, in some embodiments, affect the amount of other ingredients added to a mix or ice cream.

In many embodiments, in addition to denaturized whey, a frozen dairy product or mix provided herein generally comprises at least water, oil, milk protein, and one or more carbohydrates. Some embodiments of a frozen dairy product or mix generally comprises butterfat, milk solids non-fat (“MSNF”), sweeteners, water and optional other ingredients, e.g., flavors, salt, stabilizers, emulsifiers, and the like. In some embodiments, only dairy products are used as fatty ingredients in the mix. Some embodiments of a frozen dairy product or mix comprise edible inclusions (solid), such as nuts, solid fruit pieces, cookie chips, and the like, which are typically distributed within the mix or frozen dairy product. Some embodiments of a frozen dairy product contain sugar, condensed skim milk, cream, egg yolk, water and optionally flavorants. Some embodiments of a frozen dairy product or mix according to the invention contain fat in an amount of about 11% to about 22%, MSNF in an amount of about 7% to about 12%, added sugar in an amount of about 10% to about 20%, egg yolk solids in an amount of about 2% to about 6%, total solids in an amount of about 41% to about 51%, water and optionally flavorants. Some embodiments of a frozen dairy product or mix according to the invention contain fat in an amount of about 9% to about 12%, MSNF in an amount of about 11 to about 14%, added sugar in an amount of about 9% to 13%, egg yolk solids in an amount of about 2% to about 4%, total solids in an amount of about 39 to 43%, yogurt in an amount of about 33% to about 36%, water and optionally flavorants. Some embodiments of a frozen dairy product or mix contain fat in an amount of about 4% to 9%, MSNF in an amount of about 7 to about 9%, added sugar in an amount of about 2% to about 3%, egg yolk solids in an amount of about 3% to 4%, total solids in an amount of about 37% to about 44%, water and optionally flavorants. Some embodiments of a frozen dairy product or mix contain condensed skim milk in an amount of 16% to about 30%, cream in an amount of about 30% to about 45%.

Methods A mix provided herein can be in dry form or liquid form. A dry mix is hydrated to form a liquid mix prior to use to make a frozen dairy product.

A mix provided herein can be made by combining a native or denaturized exogenous whey protein with other ingredients at the appropriate concentrations in any appropriate order. In some embodiments, dry ingredients can be combined to produce a dry blend containing some or all of the dry ingredients, followed by adding wet ingredients (e.g., milk, yogurt, water, exogenous fats, and the like) to make a homogenous mixture. Preferably, a dry mix can contain exogenous whey protein, e.g., as a native whey protein powder or a denaturized whey protein powder. However, if a denaturized whey protein solution is used, it can optionally be added at the same time as other wet ingredients. In some embodiments, a mix can be heated to facilitate uniform blending. For example, a mix can be heated to a temperature of about 65° C. to about 80° C.

A mix is typically pasteurized after combining the appropriate ingredients. A mix can be pasteurized using a batch process or a continuous process. If the mix contains native exogenous whey, the mix can be pasteurized at a time and temperature suitable for denaturing the native exogenous whey as described above (e.g., about 85° C. to about 105° C. for about 2 minutes to about 10 minutes).

If the whey protein included in a mix was denatured prior to addition to the mix, the mix can be pasteurized using any suitable pasteurization method, such as those more typical of treating mixes formulated for making frozen dairy products (e.g., a temperature of 80° C. to 85° C. for less than 2 minutes). Although it is more efficient to pasteurize a mix after all the ingredients have been combined, in some embodiments, a mix need not be pasteurized if individual ingredients are pasteurized separately.

In some embodiments, a mix can be homogenized. A mix can be homogenized before or following pasteurization. If present, flavorants are preferably added following pasteurization to reduce the impact of heat and/or homogenization on flavor and/or integrity of solid inclusions.

A mix provided herein can have a viscosity range of from about 100 cp to about 5000 cp (0.1 Pa·s to 5 Pa·s) at 5° C. following pasteurization and/or homogenization.

In some embodiments, a mix can be stored prior to being used to make a frozen dairy product. A mix can be stored at any appropriate temperature, typically above freezing. For example, a mix can be held at room temperature (e.g., about 20° C.) or chilled (e.g., below 20° C., or at about 4° C.).

A mix can be used to make a frozen dairy product using any known method. Typically, a mix is chilled to a temperature below 0° C. (e.g., below −5° C., or from about −10° C. to about −25° C.) to produce a frozen dairy product. A mix can be optionally aerated before or during the chilling process to produce a frozen dairy product.

In some embodiments, a process for preparing a frozen dairy product includes a step of preparing a mix, pasteurizing and homogenizing the mix, freezing and aerating the pasteurized and homogenized mix to form a soft ice, and hardening the soft ice to produce the frozen dairy product. In some embodiments, a soft ice is extruded into a package and then hardened in the package. If a soft ice is extruded, the extrusion temperature is typically in the range of about −3° C. to about −10° C. (e.g., about −5° C. to about −9° C.).

Aeration increases the volume of the frozen dairy product. The volume increase is known as overrun. Overrun (%) is classically defined as the percent increase in the volume of a frozen dairy product relative to a mix as the result of the air that is incorporated during the freezing and whipping process. For example, if 1 L of mix produces 2 L of frozen dairy product (i.e., 1 L of air whipped into a 1 L mix), the overrun is said to be 100%. In some embodiments, a mix provided herein can be aerated to result in a low overrun, or an overrun of less than 75%. In some embodiments, a frozen dairy product provided herein can have an overrun from about 15% to 75%. In some embodiments, a frozen dairy product provided herein can have an overrun from about 22% to about 55%. In some embodiments, a frozen dairy product provided herein can have an overrun from about 20% to about 50%.

A frozen dairy product made from a mix provided herein can have a reduced iciness perception over shelf life. In some embodiments, a frozen dairy product provided herein can maintain an average ice crystal size of less than 90 μm (e.g., 80 μm or less, or from 40 μm to 75 μm) at week 5 of an accelerated shelf life test (ASLT), as determined according to the methods described in the Examples herein.

A frozen dairy product made from a mix provided herein can have increased melt resistance. In some embodiments, a frozen dairy product provided herein can have a melt time of at least 60 minutes (e.g., at least 70 minutes, or at least 100 minutes), as determined according to the method described in the Examples herein.

The skilled artisan will appreciate that the above described preferred product embodiments contain only milk based ingredients, sweeteners, flavors, and other ingredients (e.g., egg yolk) perceived as natural, and do not contain any emulsifiers, stabilizers or other ingredients perceived by consumers as being artificial. Accordingly, it is an advantage that the present invention can be used to prepare milk based aerated frozen desserts which are “all natural,” which for purposes of this invention is used to describe products hereof which are free of added emulsifiers and stabilizers. Advantageously, such “all natural” product can also successfully be made as low fat.

The present dessert compositions can optionally contain a variety of additional ingredients suitable for rendering such compositions even more organoleptically or aesthetically desirable or nutritious. Such optional ingredients include, for example, flavors, coloring agents, nuts, cookie bits, vitamins, preservatives and the like. If present, such minor optional components should each comprise about 0.1% to 5% by weight of the frozen dairy product.

One preferred optional ingredient is conventional stabilized fruit for frozen dairy product. Stabilized fruit for frozen dairy product is commonly used in the frozen dairy product industry. Such material comprises fruit pieces which have been sugar or gum treated to remain soft at the typical freezer temperatures at which a frozen dairy product is typically stored. Stabilized fruit can be desirably added to the present composition just prior to aeration and freezing.

### EXAMPLES

Testing and Measurement Methods

Measurement of Total Solid and Fat Content after Homogenization Step

Fat and total solid content of ice cream mix were measured by DS2500 device. The DS2500 (Foss Analytics, Foss France 35 rue des peupliers, 92752 Nanterre Cedex) is a quick, near-infrared analyzer that measures fat and total solid from ice cream mixes. It uses the principle of reflectance. The device was calibrated with the ANN Calibration to be qualified on the scope of fat and total solid content of the products of the examples.

Measurement of Viscosity

Viscosity is measured using a coaxial cylinder geometry at a constant shear rate of 60 1/sec for 10 seconds at a temperature of 5° C. Viscosity is evaluated at 10 seconds.

% Overrun:

Overrun is set as follows:

% Overrun=(Volume of ice cream−Volume of mix used)/Volume of mix used×100%

Method for Measuring Ice Crystals

Equipment:

A Nikon Eclipse LV 100 ND microscope is used. This microscope is equipped with a plate with a thermoelectric effect to keep sample frozen. The plate temperature is managed by software Linksys 32. The temperature of the plate is maintained at minus 20° C. thanks to thermoelectric effect.

Sample Preparation:

Ice cream samples are stored at −20° C. at least 1 day before analysis. The sampling preparation is done in a freezer at −20° C., as follows:
Remove around 1 cm of ice cream at the middle of the pot
Take a very small sample and put it on a slide stored at −20° C.
Place a drop of immersion oil on small sample
Put a coverslip on sample
When the slide is ready, put it very fast in the thermoelectric effect plate to avoid any melting of ice cream.

Ice Crystals Measurement
An 10× objective is used;
The software Archimede is used to measure ice crystals to give a picture of ice crystals; the ice crystals size is measured as follows:

2 slides are prepared for each ice cream sample;

5 pictures of ice crystals are taken;

On each picture, the size of 10 different ice crystals are randomly measured.

On this basis: 10 measurements/picture*5 pictures*2 slides=>100 measurements by samples.

Then the average of the 100 measurements has been calculated.

Measurement of Ice Crystals Stability: Accelerated Shelf Life Testing (ASLT)/Ice Crystals

Experiments with frozen dairy products have been performed to show the effect of the denaturized exogenous whey proteins on crystal size after ASLT. For a same formulation but with denaturized exogenous whey proteins, the evolution of the average size of the crystals during the shelf life of the product is less apparent with denaturized exogenous whey proteins.
The samples are stored for an accelerated shelf life test (ASLT) at −12.2° C. instead of −26° C. at selected intervals as follows:
a. Week 0: the sample is stored in control freezer (−26° C.)
b. Week 1: the sample is stored at −12.2° C. during one week then hold in the control freezer
c. Week 3: the sample is stored at −12.2° C. during three weeks and hold in the control freezer. 3 weeks are representative of a product in a middle of life (6 months when the sample is stored in classical conditions)
d. Week 5: the sample is stored at −12.2° C. during five weeks and hold in the control freezer. 5 weeks are representative of a product at the end of this life (1 year when the sample is stored in classical conditions)

Measurement of Melting Time

Frozen dairy products have undergone a meltdown test to show the effect of the invention on the meltdown resistance. Briefly, samples are stored at −25° C. prior to testing. The meltdown test is performed in a meltdown analyzer, under controlled and constant conditions of temperature (20° C.) and humidity (80%). Each standardized frozen dairy product sample (samples all have the same volume and shape) is placed on a perforated tray positioned above a recovery plate in the meltdown analyzer. Every 5 seconds, weight loss of sample on the perforated tray is recorded and weight of sample collected on the recovery plate is recorded. Melting time is recorded as the time at which weight loss of a sample is at 0.5% of the initial sample weight. Tests are performed in 2 repetitions.

Measurement of Denaturized Whey Protein Content

Measurement of denaturized whey protein content is a modified method derived from ISO 17997-1/FIL 29. Generally, denaturized whey protein content is calculated from measured quantities of total milk protein nitrogen content (TMPN) (method used: ISO 8968-1:2014), non-protein nitrogen (NPN) (method used: ISO 8968-4:2016), and non-casein nitrogen (NCN) (method used: ISO 17997-1/FIL 29). Briefly, total milk protein nitrogen content and NPN are measured directly from a sample. NCN is measured from a same-source sample after precipitating casein by the addition of acetic acid and sodium acetate solutions to achieve a pH of approximately 4.6, and removing casein by filtration, so that the remaining filtrate can be tested to measure NCN.
Denaturized whey protein content is determined using the following formulas, where DWP is denaturized whey protein content, DWPN is denaturized whey protein nitrogen, TWPN is total whey protein nitrogen, SWPN is soluble whey protein nitrogen, TMPN is total milk protein nitrogen:

DWP=6.38*DWPN Formula 1:

DWPN=TWPN−SWPN Formula 2:

TWPN=0.2*TMPN−SWPN Formula 3:

SWPN=NCN−NPN Formula 4:

### Example 1—Stabilized Frozen Yogurt

Mixes for frozen yogurt were made containing 35% by weight of a double cream milk yogurt, and treated according to Table 1. Denaturized whey protein in Sample 2 was made by heating a 7.5% native whey protein solution in water at neutral pH at 85° C. for 15 minutes under moderate agitation. Pasteurization was performed prior to adding the yogurt to the mix.

TABLE 1

| | 1 | | | |
|---|---|---|---|---|
| Sample | (Control) | 2 | 3 | 4 |
| Exogenous | 0% | 1.9% | 1.9% | 1.9% |
| whey protein (by | | denaturized | native | native |
| weight final | | whey | whey | whey |
| product) | | protein | protein | protein |
| Pasteurization | 82.5° C. | 82.5° C. | 82.5° C. | 90° C. |
| | for 90 | for 90 | for 90 | for 6 |
| | seconds | seconds | seconds | minutes |
| Melting time | 29 | 74 | 33 | 82 |
| (minutes) | | | | |
| Ice crystal | 64 | 59 | *NA | 59 |
| size (μm), Week | | | | |
| 0 ASLT | | | | |
| Ice crystal | 117 | 62 | *NA | 63 |
| size (μm), Week | | | | |
| 5 ASLT | | | | |
| Calculated | 0.30 | 2.07 | 1.17 | 2.29 |
| denaturized whey | | | | |
| protein content in | | | | |
| mix (% by weight) | | | | |

*NA = not analyzed

Sample 2, which contained whey protein that was denaturized prior to inclusion in the mix, had significantly reduced ice crystal size at week 5 ASLT, as compared to the Control. Sample 4, in which exogenous whey protein was denatured during pasteurization of the mix (90° C. for 6 minutes), also had significantly reduced ice crystal size at week 5 ASLT relative to Control. In addition, Sample 2 and Sample 4 had a much longer melting time relative to Control. Importantly, Sample 4 also had a longer melting time than Sample 3, which contained exogenous native protein, but was pasteurized at a temperature insufficient to denature the exogenous whey protein completely. Only about 50% of the exogenous whey protein was denatured at a pasteurization process of 82.5° C. for 90 seconds.

### Example 2—Stabilized Ice Cream

Mixes for a vanilla ice cream were made and treated according to Table 1. Denaturized whey protein in Sample 6 was made by thermal denaturation of native whey protein followed by drying, and the dried, powdered product was used in the mix.

TABLE 2

| Sample | 5 (Control) | 6 |
|---|---|---|
| Exogenous | 0% | 1.6% |
| whey protein (by | | denaturized |
| weight final product) | | whey protein |
| Pasteurization | 82.5° C. for | 82.5° C. for |
| | 90 seconds | 90 seconds |
| Melting time | 71 | 125 |
| (minutes) | | |
| Calculated | 0.36 | 2.01 |
| denaturized whey | | |
| protein content in | | |
| mix (% by weight) | | |

Sample 6, which contained whey protein that was denaturized prior to inclusion in the mix, had significantly improved melt resistance relative to Control.

The implementations described above and other implementations are within the scope of the following claims. One skilled in the art will appreciate that the present disclosure can be practiced with embodiments other than those disclosed. The disclosed embodiments are presented for purposes of illustration and not limitation.

1. A mix for a frozen dairy product, wherein said mix comprises denaturized whey protein at a concentration of at least 1%, at least 1.5%, or at least 2%, by weight relative to a total weight of the mix, excluding the weight of solid inclusions, if any, wherein the mix either:
has a pH below 5 and comprises, by weight of the mix, excluding the weight of solid inclusions, if any:
a. fat in amount of about 8% to about 13%,
b. milk solids nonfat (MSNF) in an amount of about 10% to about 15%,
c. added sugar in an amount of about 8% to about 15%,
d. egg yolk solids in an amount of about 1% to about 5%,
e. total solids in an amount of about 35% to about 45%, and
f. yogurt in an amount of about 29% to about 38%,
has a pH of at least 5 and comprises, by weight of the mix, excluding the weight of solid inclusions, if any:
a. fat in amount of about 11% to about 25%,
b. milk solids nonfat (MSNF) in an amount of about 6% to about 13%,
c. added sugar in an amount of about 8% to about 25%,
d. egg yolk solids in an amount of about 1% to about 8%, and
e. total solids in an amount of about 40% to about 55%,
or
has a pH of at least 5 and comprises, by weight of the mix, excluding the weight of solid inclusions, if any:
a. fat in amount of about 3% to about 10%,
b. milk solids nonfat (MSNF) in an amount of about 6% to about 10%,
c. added sugar in an amount of about 1% to about 5%,
d. egg yolk solids in an amount of about 2% to about 5%, and
e. total solids in an amount of about 35% to about 45%.

2. The mix according to claim 1, wherein the denaturized whey protein content is about 2% to about 5% by weight of the mix.

3. The mix according to claim 1, wherein the frozen dairy product is frozen yogurt.

4-6. (canceled)

7. The mix according to claim 1, wherein the frozen dairy product is an ice cream or a gelato.

8-9. (canceled)

10. Process for preparing the mix for a frozen dairy product as defined in claim 1, wherein said process comprises:
a. adding denaturized whey protein to other ingredients to form the mix, or
b. adding exogenous native whey protein to other ingredients and denaturing the exogenous native whey protein at least in part to form the mix.

11. The process of claim 10, wherein said process comprises a pasteurization of the mix, said pasteurization step also denaturing at least in part the exogenous native whey protein in the mix.

12. The process of claim 11, wherein said pasteurization is performed at a temperature in the range of 85° C. to 100° C.

13. The process of claim 11, comprising a step of freezing the mix to produce a frozen dairy product.

14. A frozen dairy product having a pH below 5, wherein said product comprises the mix as defined in claim 1, or is obtainable according to a process as defined in claim 13.

15. A frozen dairy product having a pH of at least 5, wherein said product comprises the mix as defined in claim 1, or is obtainable according to a process as defined in claim 13.

16. A method for stabilizing ice crystals in a frozen dairy product, wherein said method comprises adding exogenous whey protein to a mix for a frozen dairy product, said added whey protein being in the form of denaturized whey protein prior to addition to the mix or being denaturized prior to freezing the mix.

17. A method for improving melting resistance in a frozen dairy product, wherein said method comprises adding denaturized whey protein to a mix for a frozen dairy product, said added whey protein being in the form of denaturized whey protein prior to addition to the mix or being denaturized prior to freezing the mix.

18. Use of denaturized whey protein for improving melting resistance or slowing down the melting of a frozen dairy product having a pH below 5, said frozen dairy product comprising a mix as defined in claim 1, or being obtainable according to a process as defined in claim 10.

19. Use of denaturized whey protein for improving melting resistance or slowing down the melting of a frozen dairy product having a pH of at least 5, said frozen dairy product comprising a mix as defined in claim 1, or being obtainable according to a process as defined in claim 10.

20. The mix according to claim 1, wherein the mix includes:
a. the fat in the amount of about 8% to about 13%,
b. the milk solids nonfat (MSNF) in the amount of about 10% to about 15%,
c. the added sugar in the amount of about 8% to about 15%,
d. the egg yolk solids in the amount of about 1% to about 5%, and
e. the total solids in the amount of about 35% to about 45%.

21. The mix according to claim 1, wherein the mix includes:
a. the fat in the amount of about 11% to about 25%,
b. the milk solids nonfat (MSNF) in the amount of about 6% to about 13%,
c. the added sugar in the amount of about 8% to about 25%,
d. the egg yolk solids in the amount of about 1% to about 8%, and
e. the total solids in the amount of about 40% to about 55%.

22. The mix according to claim 1, wherein the mix includes:
a. the fat in the amount of about 3% to about 10%,
b. the milk solids nonfat (MSNF) in the amount of about 6% to about 10%,
c. the added sugar in the amount of about 1% to about 5%,
d. the egg yolk solids in the amount of about 2% to about 5%, and
e. the total solids in the amount of about 35% to about 45%.
